(19) United States
(12) Patent Application Publication
(10) Pub. No.: US 2012/0060777 A1
(43) Pub. Date: Mar. 15, 2012

(54) Hydrostatic Fan Drive

(75) Inventors: Seppo Antero Tikkanen, Tampere (FI); Karl-Heinz Vogl, Ummendorf (DE); Matthias Mueller, Langenau (DE); Peter Schmuttermair, Gessertshausen (DE)

(73) Assignee: Robert Bosch GmbH, Stuttgart (DE)

(21) Appl. No.: 13/145,339

(22) PCT Filed: Jan. 21, 2010
(86) PCT No.: PCT/DE10/00068

§ 371 Date: Nov. 29, 2011

(30) Foreign Application Priority Data
Jan. 22, 2009 (DE) 10 2009 005 700.5

(51) Int. Cl. F01P 7/02; F15B 11/02; F15B 1/02; F15B 11/08; F15B 15/20

(52) U.S. Cl. 123/41.11; 60/325; 60/487; 60/413; 60/448

(57) ABSTRACT

A hydrostatic fan drive for internal combustion engines is disclosed, having a primary unit that can be driven by the internal combustion engine, and having a fan motor by means of which a blower fan can be driven. A hydraulic reservoir is disposed at a high-pressure line connecting the primary unit to the fan motor. A hybrid fan drive for internal combustion engines is thus provided, allowing fan operation even if the internal combustion engine is switched off. An increased maximal available power of the internal combustion engine is available in transition, despite the fan operation, because the fan motor can be supplied with pressurized media by the hydraulic reservoir in such cases (in transition).

The invention relates to a hydrostatic fan drive for internal combustion engines in accordance with the preamble of patent claim 1.

In the case of internal combustion engines, a cooling system is necessary to carry away the often considerable waste heat, and this cooling system is generally boosted by a rotating fan impeller. Here, the fan impeller is driven directly by a power takeoff shaft of an internal combustion engine or by way of a hydraulic circuit, the latter having a pump driven by the power takeoff shaft and a motor driving the fan impeller.

Publication DE 43 21 637 has disclosed a hydrostatic fan drive for internal combustion engines which has a variable-displacement pump that is driven by the internal combustion engine and drives a fan impeller by way of a constant-displacement motor. Since the rotational speed of the variable-displacement pump is directly dependent on that of the output shaft of the internal combustion engine, the fan output is controlled by setting the delivery volume of the variable-displacement pump.

Publication U.S. Pat. No. 6,311,488 shows comparable fan drives in which variable-displacement motors connected to the fan impeller are shown in addition to constant-displacement motors, thereby achieving improved suitability for control of the fan drives.

The disadvantage with hydrostatic fan drives of this kind is their coupling to the driving internal combustion engine, which does not permit fan operation when the internal combustion engine is switched off. Moreover, the power output of the internal combustion engine is also reduced when maximum power is demanded of it.

In contrast, it is the underlying object of the invention to provide a hydrostatic fan drive for internal combustion engines which allows the fan to be operated even when the internal combustion engine is switched off. The intention is furthermore to achieve an increase in the maximum power that can be demanded from the internal combustion engine in transitional phases, despite operation of the fan.

This object is achieved by a hydrostatic fan drive for internal combustion engines as claimed in patent claim 1 or by a method for operating a hydrostatic fan drive in accordance with one of claims 22 to 24.

Further advantageous embodiments of the invention are described in the dependent patent claims.

The hydrostatic fan drive according to the invention for internal combustion engines has a primary unit, which can be driven by the internal combustion engine, and a fan motor, by means of which a fan impeller can be driven. In this arrangement, a hydraulic accumulator is connected to a high-pressure line, which connects the primary unit to the fan motor. A hybrid fan drive for internal combustion engines is thus provided which allows the fan to be operated even when the internal combustion engine is switched off. Furthermore there is an increase in the maximum power that can be demanded from the internal combustion engine in transitional phases, despite operation of the fan, since the fan motor can be supplied with pressure medium from the hydraulic accumulator in these cases (in transitional phases).

In a particularly preferred development, an accumulator shutoff valve is arranged in a connecting line, which connects the high-pressure line and the hydraulic accumulator. This enables the hydraulic accumulator to be isolated, when it is full for example, and to be reconnected only when required.

It is particularly preferred if the primary unit is an adjustable axial piston machine. This primary adjustment of the fan output makes it possible to dispense with a loss-prone pressure-reducing valve for controlling the fan output.

In a particularly preferred development of the fan drive according to the invention, having a fan shutoff valve, the internal combustion engine is coupled to at least one wheel of a land vehicle or to at least one propeller of a watercraft. When the fan drive according to the invention is used in vehicles of this kind, at least part of the braking energy during the braking of the vehicle can be used to charge the hydraulic accumulator by way of the engaged internal combustion engine and the axial piston machine (which is operated as a pump).

In a particularly preferred variant of the fan drive according to the invention, having an adjustable axial piston machine, the axial piston machine can be adjusted beyond zero while maintaining the direction of rotation and can thus be used as a pump and as a motor. Moreover, a fan shutoff valve is arranged in a section of the high-pressure line which connects the fan motor to the hydraulic accumulator or to the connecting line. As a result, it is also possible to feed the energy from the charged hydraulic accumulator back to the internal combustion engines via the axial piston machine when the latter is used as a motor, e.g. in order to start said engines or to increase the maximum power thereof (in transitional phases).

It is furthermore advantageous if the fan shutoff valve is formed by a 2/2-way valve, the valve element of which connects a high-pressure port of the axial piston machine to a high-pressure port of the fan motor via the high-pressure line in a normal position, in which it is preloaded by a spring, whereas, in its operating position, it shuts off this connection.

In a particularly preferred variant of the fan drive according to the invention, costs lead to the choice of a fan motor that is a constant-displacement axial piston motor which has the high-pressure port connected to the high-pressure line and furthermore has a low-pressure port connected to a tank by a tank line.

It is preferred if the accumulator shutoff valve is formed by a 3/3-way valve, the valve element of which connects the high-pressure line to the hydraulic accumulator via the connecting line in its first operating positions, while closing the connection to the tank line. In the second operating positions of the valve element, the high-pressure line is connected to the tank line, while the hydraulic accumulator is shut off. Finally, in a normal position of the valve element, in which it is centered by springs, the hydraulic accumulator and also the connection between the high-pressure line and the tank line is shut off. The first operating positions enable the hydraulic accumulator to be charged or discharged while the second operating positions and the normal position shut off the hydraulic accumulator (e.g. in the charged state).

As an alternative, for reasons of cost, the accumulator shutoff valve can be formed by a 2/2-way valve, the valve element of which connects the high-pressure line to the hydraulic accumulator via the connecting line in its operating position and shuts off said connection in its normal position, in which it is preloaded by a spring.

In another particularly preferred variant of the fan drive according to the invention, the fan motor is an adjustable axial piston motor, the rotational speed of which can be set by adjusting a pivoting angle. Here, a first port of the fan motor is connected to a reversing valve by a first working line, and a second port of the fan motor is connected to said reversing valve by a second working line, said reversing valve being connected to the primary unit by the high-pressure line and to a tank by a tank line. This makes it possible to change the direction of rotation of the fan impeller in order, for example, to blow dirt out of the fins or gills of a radiator.

At the same time, it is preferred if the reversing valve is formed by a 2/2-way valve, the valve element of which connects the high-pressure line to the first working line and the second working line to the tank line in a normal position, in which it is preloaded by a spring, and connects the high-pressure line to the second working line and the first working line to the tank line in its operating position.

In a third particularly preferred variant of the fan drive according to the invention, the fan motor is an adjustable axial piston motor, the rotational speed and direction of rotation of which can be set by adjusting a pivoting angle. wherein a high-pressure port of the fan motor is connected to the high-pressure line, and wherein a low-pressure port of the fan motor is connected to a tank by a tank line. This likewise makes it possible to change the direction of rotation of the fan impeller in order, for example, to blow dirt out of the fins or gills of a radiator.

To limit the pressure or for reasons of safety, a pressure-limiting valve, which relieves pressure to the tank, is arranged adjacent to the hydraulic accumulator in a section of the connecting line.

In a particularly preferred development, the fan drive according to the invention has an electronic control unit, by means of which the pivoting angle of the primary unit and/or the positions of the respective valve elements of the fan shutoff valve, the accumulator shutoff valve and the reversing valve and, if required, the pivoting angle of the fan motor can be set.

The control unit can preferably be connected to an electronic engine control unit of the internal combustion engine.

A pressure sensor can preferably be arranged on the section of the connecting line which is arranged between the accumulator shutoff valve and the hydraulic accumulator, or on a section of the connecting line which is arranged between the accumulator shutoff valve and the high-pressure line. This sensor is likewise connected to the control unit.

In an advantageous embodiment, a rotational speed sensor, which is likewise connected to the control unit, is arranged at the fan impeller or at the fan motor.

It is preferred if the fan shutoff valve and/or the reversing valve and/or the accumulator shutoff valve are continuously adjustable proportional valves. This makes it possible to produce a throttled flow that can be set in order to rapidly increase the operating or exhaust gas temperature of the internal combustion engine, which is required for regeneration of a particulate filter, for example. Moreover, the jolt-free switching-over of the fan shutoff valve and of the reversing valve reduces the stress on the fan motor and the fan impeller.

In a development of the fan drive, which is also suitable for relatively high and/or more relatively prolonged evolution of heat, a radiator is arranged in the tank line, a spring-preloaded check valve being provided for reasons of system safety in a bypass line arranged in parallel with the radiator, said valve opening the bypass line if a minimum pressure is exceeded.

If a check valve, which opens from the axial piston pump to the hydraulic accumulator and to the fan motor, is provided adjacent to said pump in the high-pressure line for reasons of safety, torque transmission to the drive train is not possible. At the same time, leakage during the operation of the fan by the hydraulic accumulator is reduced.

In a method for controlling the fan drive according to the invention during a braking operation of a land vehicle, a pivoting angle of the axial piston pump is set by way of a setpoint braking torque and a pivoting angle of the fan motor is set by way of a setpoint rotational speed and by way of a fan pressure/rotational speed characteristic.

In a method for controlling the fan drive according to the invention during an acceleration of a land vehicle, a pivoting angle of the fan motor is set by way of a fan pressure/rotational speed characteristic, and a pivoting angle of the axial piston pump is simultaneously set to zero if the pressure in the hydraulic accumulator is sufficient for a setpoint rotational speed of the fan motor. This relieves the load on the internal combustion engine.

By means of the adjustable pump and the adjustable fan motor, it is possible to set the pivoting angles of the pump and the fan motor in accordance with the setpoint rotational speed of the fan motor and the torque, thereby defined, of the fan motor for optimum efficiency.

This is ideally accomplished by means of a characteristic map (in accordance with the rotational speeds of the fan motor and the pump).

Various illustrative embodiments of the invention are described in detail below with reference to the figures, of which:

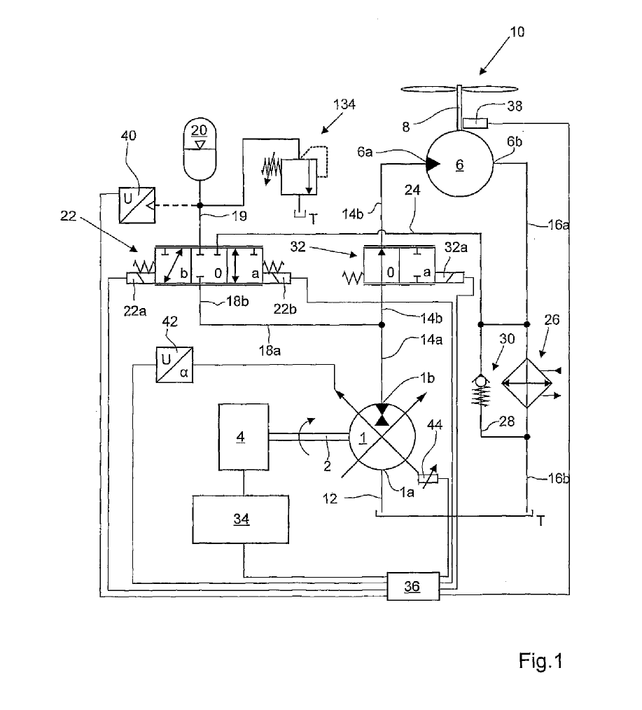

FIG. 1 shows a circuit diagram of a first illustrative embodiment of a hydrostatic fan drive according to the invention;

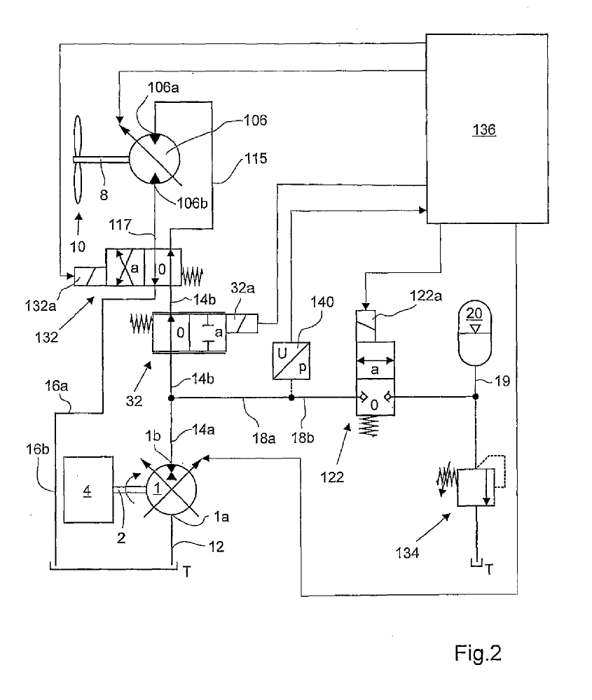

FIG. 2 shows a circuit diagram of a second illustrative embodiment of a hydrostatic fan drive according to the invention; and

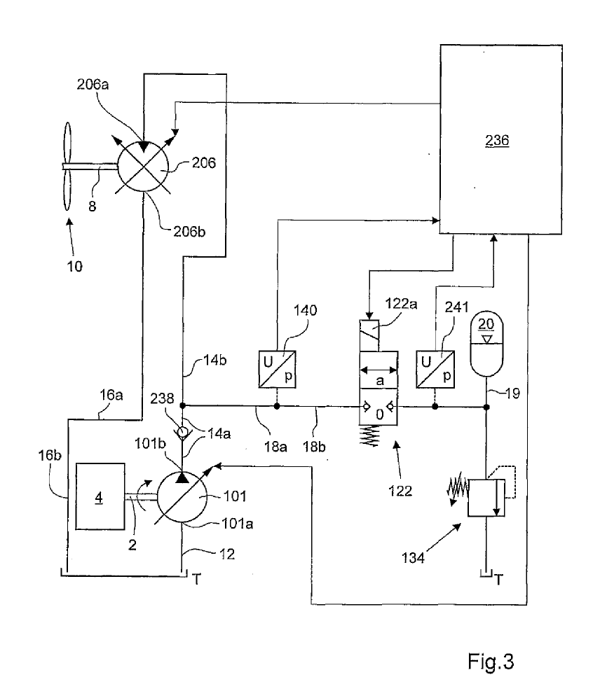

FIG. 3 shows a circuit diagram of a third illustrative embodiment of a hydrostatic fan drive according to the invention.

FIG. 1 shows a block circuit diagram of a first illustrative embodiment of a hydrostatic fan drive according to the invention. It has essentially an adjustable axial piston machine 1, which is connected to an internal combustion engine 4 by a shaft 2.

The fan drive furthermore has a fan motor 6, which is embodied as a constant-displacement axial piston motor and drives a fan impeller 10 by way of an output shaft 8. This fan impeller 10 blows cooling air through a radiator (not shown) of the internal combustion engine 4.

The axial piston machine 1 and the fan motor 6 are arranged in an open hydraulic circuit with a tank T, which is connected to a low-pressure port 1a of the axial piston machine 1 via an intake line 12 and connects a high-pressure port 1b of the axial piston machine 1 to a high-pressure port 6a of the fan motor 6 via a high-pressure line 14a, 14b. The fan motor 6 furthermore has a low-pressure port 6b, which is connected to the tank T by a tank line 16a, 16b.

Branching off from the high-pressure line 14a, 14b is a connecting line 18a, 18b, 19, via which, in accordance with the invention, a hydraulic accumulator 20 is connected to the high-pressure line 14a, 14b. A continuously adjustable 3-way valve 22, which is designed as a 3-position valve, is formed in the connecting line 18a, 18b, 19. The valve 22 is connected to the two sections 18b, 19 of the connecting line and to a further connecting line 24, which opens into the tank line 16a, 16b.

A radiator 26, and a bypass line 28 in parallel therewith, is arranged in the tank line 16a, 16b downstream of the entry of the connecting line 24 into the tank line 16a, 16b. A check valve 30, which opens counter to a spring in the direction of the tank T at a predetermined pressure, is provided in the bypass line 28.

A fan shutoff valve 32 is arranged in a section 14b of the high-pressure line 14a, 14b upstream of the connection of the hydraulic accumulator 20. It is designed as a 2/2-way valve, the valve element of which connects the high-pressure port 1b of the axial piston machine 1 to the high-pressure port 6a of the fan motor 6 via the high-pressure line 14a, 14b in a normal position (0), in which it is preloaded by a spring. When an electromagnet 32a of the fan shutoff valve 32 is actuated, the valve element of said valve is moved counter to the spring into an operating position (a), with the result that the high-pressure line 14a, 14b is shut off.

For control of the internal combustion engine 4, said engine has an electronic engine control unit 34.

For control of the fan drive according to the invention, as shown in FIG. 1, said drive has an electronic control unit 36. The control unit 36 receives a measurement signal relating to the rotational speed of the fan motor 6 with the output shaft 8 and the fan impeller 10 from a rotational speed sensor 38. The control unit 36 furthermore receives a measurement signal relating to the pressure in the hydraulic accumulator 20 from a pressure sensor 40 and a measurement signal relating to the pivoting angle of the axial piston machine 1 from a sensor 42.

The control unit 36 outputs control signals to a pivoting-angle setting device 44 of the axial piston machine 1 and to the electromagnets 32a, 22a, 22b of the fan shutoff valve 32 and of the 3/3-way valve 22.

The operation of the fan drive according to the invention, as shown in FIG. 1, will be explained below.

During normal operation of the fan drive, the internal combustion engine 4 drives the axial piston machine 1, which is operated as a pump, by way of the shaft 2. It pumps pressure medium from the tank T via the intake line 12 and the high-pressure line 14a, 14b to the fan motor 6, which drives the fan impeller 10 as a result. In this case, the valve element of the fan shutoff valve 32 is in its spring-preloaded normal position (0). The pressure medium flows back from the fan motor 6 to the tank T via the tank line 16a, 16b. In the process, it flows via the radiator 26 or, in the case where the flow resistance is too high, via the bypass line 28, the check valve 30 of which opens counter to the spring in this case.

The output at the fan impeller 10 is controlled by varying a piston stroke of the axial piston machine by means of the pivoting-angle setting device 44 thereof.

If the fan output is higher than necessary or if the internal combustion engine 4 is being operated in a suboptimum underload range, a valve element of the 3/3-way valve 22 can be adjusted in the direction of the positions a thereof, causing pressure medium to flow from the high-pressure line 14a via the connecting line 18a, 18b, 19 to the hydraulic accumulator 20 and to charge the latter.

After the hydraulic accumulator 20 has been charged, the 3/3-way valve 22 can close the connecting line 18a, 18b, 19 again.

If, for example, a fan output is required even though the internal combustion engine 4 is switched off or if the internal combustion engine 4 is to be operated at maximum power, the 3/3-way valve 22 can be opened if the hydraulic accumulator 20 is charged. If the fan shutoff valve 32 is opened in this case, the fan motor 6 can be supplied with pressure medium, even if the internal combustion engine 4 is stationary or insufficient pressure medium is being delivered by means of the axial piston machine 1. If, on the other hand, the fan shutoff valve 32 is closed, the pressure medium from the hydraulic accumulator 20 can supply the axial piston machine 1 with pressure medium at its high-pressure port 1b, thus operating the latter as a motor. If the pivoting angle of the axial piston machine 1 is adjusted beyond 0° in this case, the direction of rotation of the shaft 2 corresponds to that in the operating condition described above. The internal combustion engine 4 is thus additionally driven or supported by the fan drive according to the invention, and this is advantageous particularly if the internal combustion engine 4 is to be operated at maximum load.

FIG. 2 shows the circuit diagram of a second illustrative embodiment of the fan drive according to the invention. It has adjustable axial piston machine 1, which is driven by the internal combustion engine 4 by way of the shaft 2. As a result, the axial piston machine 1 delivers pressure medium from the tank T via the intake line 12, the high-pressure line 14a, 14b and a working line 115 to an adjustable fan motor 106, the output shaft 8 of which drives the fan impeller 10. On the low-pressure side, the pressure medium flows out of the fan motor 106 via another working line 117 and via the tank line 16a, 16b and back to the tank T. A reversing valve 132 is arranged between the high-pressure line 14a, 14b and working line 115 and between working line 117 and the tank line 16a, 16b. It is designed as a 2/2-way valve, which connects the high-pressure line 14b to working line 115 and connects working line 117 to the tank line 16a in its spring-preloaded normal position (0), whereas it connects the high-pressure line 14b to working line 117 and connects working line 115 to the tank line 16a in its operating position (a).

Branching off from the high-pressure line 14a, 14b is the connecting line 18a, 18b, 19, via which the hydraulic accumulator 20 is connected to the high-pressure line 14a, 14b. An accumulator shutoff valve 122, which is designed as a 2/2-way valve, is arranged in the connecting line 18a, 18b, 19. In a spring-preloaded normal position (0), it closes the connecting line 18a, 18b, 19, whereas, in an operating position (a), it opens the connecting line 18a, 18b, 19 and thus connects the high-pressure line 14a, 14b to the hydraulic accumulator 20.

Branching off from the connecting line 18a, 18b, 19, between the 2/2-way valve 122 and the hydraulic accumulator 20, is a line in which an adjustable pressure limiting valve 134 is arranged. When a predetermined pressure in the hydraulic accumulator 20 is exceeded, it opens counter to a spring and, in the process, relieves the pressure to the tank T.

A pressure sensor 140 is arranged between the high-pressure line 14a, 14b and the 2/2-way valve 122.

For control of the fan drive according to the invention, as shown in FIG. 2, said drive has a control unit 136. It receives measurement signals relating to the pressure in the connecting line 18a, 18b and thus also in the high-pressure line 14a, 14b from the pressure sensor 140. The control unit 136 transmits actuating signals to the axial piston machine 1 and to the fan motor 106 in respect of the pivoting angle thereof. The control unit 136 furthermore supplies the electromagnets 132a, 122a of the reversing valve 132 and of the 2/2-way valve 122 with actuating signals.

The second illustrative embodiment of the fan drive according to the invention also enables the fan output to be set directly at the fan motor 106, by changing the pivoting angle thereof.

Reversal of the direction of rotation of the fan impeller 10, in order to blow dirt out of the fins or gills of a radiator (not shown) for example, is achieved by setting a valve element of the reversing valve 132 to an operating position (a).

FIG. 3 shows the circuit diagram of a third illustrative embodiment of the fan drive according to the invention, this illustrative embodiment being largely the same as that in FIG. 2. The differences are to be seen especially in the fact that an adjustable axial piston pump 101 is provided instead of the adjustable axial piston machine 1, and that an adjustable fan motor 206 can also be adjusted beyond the 0° position thereof, thus making it possible to achieve reversal of the direction of rotation of the fan impeller 10 with the above-mentioned advantage in this third illustrative embodiment too, without the need for a reversing valve (cf. FIG. 2) for this purpose.

A pressure sensor 241, which is connected to the control unit 236, is arranged on the connecting line 15 in the vicinity of the hydraulic accumulator 20. It is used, inter alia, to diagnose the pressure during automatic emptying after the switching on of a vehicle (ignition off) in which the fan drive according to the invention is arranged or to calculate the current load state of the hydraulic accumulator 20 with the 2/2-way valve 122 closed.

In the third illustrative embodiment as shown in FIG. 3 too, fuel for the internal combustion engine 4 can be saved since the energy stored in the hydraulic accumulator 20 can be used to drive the fan 10, 206, and this energy does not have to be produced by the internal combustion engine 4.

The third illustrative embodiment furthermore offers the possibility of integration, without major safety precautions, into an existing hydraulic fan drive used to cool a diesel engine in a bus. This can only be achieved because the energy stored in the hydraulic accumulator 20 is used to drive the fan 10, 206 and is not fed back into the drive train.

The charging of the hydraulic accumulator 20 and the braking of the vehicle or bus in which the internal combustion engine 4 or diesel engine with the fan drive according to the invention is arranged is accomplished by setting the volume of the axial piston pump 101 V_{g}_{_{—}}ₚᵤₘₚ to the desired torque in accordance with the pump pressure p thereof by means of the pressure sensor 140.

$${V}_{g \_ pump} = \frac{{M}_{pump \_ desired} \cdot 2 π}{p}$$

The pivoting angle αₚᵤₘₚ can be calculated from V_{g}_{_{—}}ₚᵤₘₚ by way of the rotational speed n_{engine} of the internal combustion engine 4 and the transmission ratio from the internal combustion engine 4 to the axial piston pump 101.

At the same time, V_{g}_{_{—}}_{fan} of the likewise variable fan motor 106, 206 is adjusted in such a way that the required rotational speed n_{fan}_{_{—}}_{desired} is obtained by way of the torque/rotational speed relationship of the fan impeller 10.

$${V}_{g \_ fan } = \frac{{M}_{fan} ( {n}_{fan \_ desired} ) \cdot 2 π}{p}$$

The pivoting angle α_{fan} of the fan motor 106, 206 can then be calculated using n_{fan}_{_{—}}_{desired}.

The axial piston pump 101 and the fan motor 106, 206 are thus each subject to closed-loop torque control.

The fan motor 106, 206 can also be subject to closed-loop rotational speed control and, for this purpose, the rotational speed sensor 38 shown in FIG. 1 is required.

The demands for a decelerating torque can be implemented by a higher-order controller which takes account of the relief of load on the accelerator pedal, the brake pedal and a shift in the operating point of the internal combustion engine 4. For this purpose, the fan controller supplies information on the possible torques Mₚᵤₘₚ_{_{—}}_{possible} that can be produced.

Since the braking torques that can be produced by means of the axial piston pump 101 are of the same order as the drag power of diesel engines in overrun mode, it is however also possible, by way of simplification, for activation of braking mode to take place when the accelerator pedal is in the idle position (relieved of load) and the vehicle is slowing down (actual speed>0). The supporting torque of the internal combustion engine 4 is thereby increased. This has the advantage of very simple integration.

The illustrative embodiments shown in FIGS. 1 and 2 have a fan shutoff valve 32 and an axial piston machine 1, the pivoting angle of which can be varied beyond the 0° position. The axial piston machine shown in FIG. 1 can be used as a motor in order thereby to start the internal combustion engine 4 or to increase the maximum power thereof.

Furthermore, the fan shutoff valve 32 in the first and second illustrative embodiments, the reversing valve 132 in the second illustrative embodiment and the accumulator shutoff valve 122 in the second and third illustrative embodiments can be embodied in such a way as to be continuously adjustable. This protects the fan drive from pressure peaks and torque surges.

The constant-displacement fan motor 6 in the first illustrative embodiment can also be designed as an adjustable fan motor 106 as shown in FIG. 2 or as an adjustable, pivotable fan motor 206 as shown in FIG. 3. The last-mentioned variant of the fan motor 206 is only necessary if the fan impeller 10 has to be capable of rotation to allow dirt to be blown out in both directions.

With reference to FIGS. 1 and 2, the rotational speed of the fan 6, 106, 10 can also be controlled by valve 32 if the pressure level in line 14a is higher than is required by the fan 6, 106, 10. Here, the valve 32 is either a flow control valve or a pressure-reducing valve. A flow control valve directly controls the flow for the fan motor 6, 106. A pressure-reducing valve controls the pressure level and hence the rotational speed of the fan motor 6, 106 because there is a fixed relationship between the rotational speed of the fan and the working pressure of the fan motor 6, 106. A particular rotational speed of the fan requires a particular torque (i.e. pressure for the fan motor 6, 106). This relationship can be represented as a fan characteristic in a coordinate system, on one axis of which the rotational speed of the fan and on the other axis of which the fan torque are plotted.

The setting of the valve 32 is determined by the control unit 36.

The disclosure comprises a hydrostatic fan drive for internal combustion engines, having a primary unit, which can be driven by the internal combustion engine, and having a fan motor, by means of which a fan impeller can be driven. In this arrangement, a hydraulic accumulator is arranged in a high-pressure line, which connects the primary unit to the fan motor. A hybrid fan drive for internal combustion engines is thus provided which allows the fan to be operated even when the internal combustion engine is switched off. Furthermore, there is an increase in the maximum power that can be demanded from the internal combustion engine in transitional phases, despite operation of the fan, since the fan motor can be supplied with pressure medium from the hydraulic accumulator in these cases (in transitional phases).

### LIST OF REFERENCE SIGNS

1 axial piston machine
1a low-pressure port
1b high-pressure port
2 shaft
4 internal combustion engine
6 fan motor
6a high-pressure port
6b low-pressure port
8 output shaft
10 fan impeller
12 intake line
14a, 14b high-pressure line
16a, 16b tank line
18a, 18b, 19 connecting line
20 hydraulic accumulator
22 3/3-way valve
22a, 22b electromagnet
24 connecting line
26 radiator
28 bypass line
30 check valve
32 fan shutoff valve
32a electromagnet
34 engine control unit
36 control unit
38 rotational speed sensor
40 pressure sensor
42 sensor
44 pivoting-angle setting device
101 axial piston pump
106 fan motor
115 working line
117 working line
122 2/2-way valve
122a electromagnet
132 reversing valve
132a electromagnet
134 pressure-limiting valve
136 control unit
140 pressure sensor
206 fan motor
206a high-pressure port
206b low-pressure port
236 control unit
238 check valve
241 pressure sensor
T tank

1. A hydrostatic fan drive for internal combustion engines, having a primary unit, which is configured to be driven by the internal combustion engine, and having a fan motor, by means of which a fan impeller can be driven, and further having a hydraulic accumulator that is connected to a high-pressure line connecting the primary unit to the fan motor.

2. The fan drive as claimed in patent claim 1, further having an accumulator shutoff valve that is arranged in a connecting line, which connects the high-pressure line and the hydraulic accumulator.

3. The fan drive as claimed in patent claim 1, wherein the primary unit is an adjustable axial piston machine or an adjustable axial piston pump.

4. The fan drive as claimed in patent claim 1, wherein the internal combustion engine is operatively connected to at least one wheel of a land vehicle or to at least one propeller of a watercraft.

5. The fan drive as claimed in patent claim 3, wherein the axial piston machine is configured to be adjusted beyond zero and can be used as a pump and as a motor, and wherein a fan shutoff valve is arranged in a section of the high-pressure line which connects the hydraulic accumulator or the connecting line to the fan motor.

6. The fan drive as claimed in patent claim 5, wherein the fan shutoff valve is formed by an adjustable 2/2-way valve, the valve element of which connects a high-pressure port of the axial piston machine to a high-pressure port of the fan motor via the high-pressure line in a normal position, in which it is preloaded by a spring, and, in its operating position, shuts off this connection.

7. The fan drive as claimed in patent claim 6, wherein the fan motor is a constant-displacement axial piston motor which has the high-pressure port connected to the high-pressure line and a low-pressure port connected to a tank by a tank line.

8. The fan drive as claimed in patent claim 2, wherein the accumulator shutoff valve is formed by an adjustable 3/3-way valve, the valve element of which connects the high-pressure line to the hydraulic accumulator via the connecting line in first positions, while closing a connecting line leading to the tank line, and which connects the high-pressure line to the tank line in second positions, while shutting off the hydraulic accumulator, and which shuts off the hydraulic accumulator and the connecting line leading to the tank line and the connecting line leading to the high-pressure line in a normal position, in which it is centered by springs.

9. The fan drive as claimed in patent claim 2, wherein the accumulator shutoff valve is formed by a 2/2-way valve, the valve element of which connects the high-pressure line to the hydraulic accumulator via the connecting line in its operating position and shuts off said connection in its normal position, in which it is preloaded by a spring.

10. The fan drive as claimed in patent claim 1, wherein the fan motor is an adjustable axial piston motor, the rotational speed of which can be set by adjusting a pivoting angle, wherein a first port of the fan motor is connected to a reversing valve by a first working line, and a second port of the fan motor is connected to said reversing valve by a second working line, said reversing valve being connected to the primary unit by the high-pressure line and to a tank by a tank line.

11. The fan drive as claimed in patent claim 10, wherein the reversing valve is formed by a 2/2-way valve, the valve element of which connects the high-pressure line to the first working line and the second working line to the tank line in a normal position, in which it is preloaded by a spring, and connects the high-pressure line to the second working line and the first working line to the tank line in its operating position.

12. The fan drive as claimed in patent claim 1, wherein the fan motor is an adjustable axial piston motor, the rotational speed and direction of rotation of which can be set by adjusting a pivoting angle, wherein a high-pressure port of the fan motor is connected to the high-pressure line, and wherein a low-pressure port of the fan motor is connected to a tank by a tank line.

13. The fan drive as claimed in patent claim 2, wherein a pressure limiting valve, which relieves pressure to the tank, is arranged adjacent to the hydraulic accumulator in a section of the connecting line.

14. The fan drive as claimed in patent claim 1, having an electronic control unit, by means of which the pivoting angle of the primary unit and/or the positions of the respective valve elements of the fan shutoff valve, the accumulator shutoff valve and the reversing valve can be set.

15. The fan drive as claimed in patent claim 10, wherein the pivoting angle of the fan motor can be set by means of the control unit.

16. The fan drive as claimed in patent claim 14, wherein the control unit is connected to an engine control unit of the internal combustion engine.

17. The fan drive as claimed in patent claim 14, wherein a pressure sensor, which is connected to the control unit, is arranged on the section of the connecting line which is arranged between the accumulator shutoff valve and the hydraulic accumulator, or on a section of the connecting line which is arranged between the accumulator shutoff valve and the high-pressure line.

18. The fan drive as claimed in patent claim 14, wherein a rotational speed sensor, which is connected to the control unit, is arranged at the fan impeller or at the fan motor.

19. The fan drive as claimed in patent claim 6, wherein the fan shutoff valve formed by a 2/2-way valve and/or the reversing valve formed by a 2/2-way valve and/or the accumulator shutoff valve formed by a 2/2-way valve or by a 3/3-way valve are continuously adjustable proportional valves.

20. The fan drive as claimed in patent claim 1, wherein a radiator is arranged in the tank line, a spring-preloaded check valve being provided in a bypass line arranged in parallel with the radiator.

21. The fan drive as claimed in patent claim 3, wherein a check valve, which opens from the axial piston pump to the hydraulic accumulator and to the fan motor, is provided adjacent to the axial piston pump in the high-pressure line.

22. A method for controlling the fan drive during a braking operation of a land vehicle in accordance with claim 3, wherein a pivoting angle of the axial piston pump is set by way of a setpoint braking torque and a pivoting angle of the fan motor is set by way of a setpoint rotational speed and by way of a fan pressure/rotational speed characteristic.

23. The method for controlling the fan drive during an acceleration of a land vehicle in accordance with claim 3, wherein a pivoting angle of the fan motor is set by way of a fan pressure/rotational speed characteristic, and a pivoting angle of the axial piston pump is simultaneously set to zero if the pressure in the hydraulic accumulator is sufficient for a setpoint rotational speed of the fan motor.

24. The method for controlling the fan drive in claim 3, wherein a pivoting angle of the axial piston pump and a pivoting angle of the fan motor are set in accordance with a setpoint rotational speed of the fan motor and a torque, thereby defined, of the fan motor.

25. The method as claimed in claim 24, wherein the pivoting angle of the axial piston pump and the pivoting angle of the fan motor are set by means of a characteristic map dependent on the rotational speeds of the fan motor and of the axial piston pump.
